(19) United States
(12) Patent Application Publication
(10) Pub. No.: US 2024/0172605 A1
(43) Pub. Date: May 30, 2024

(54) SUPPORTING BAR FOR TREE

(71) Applicant: UI HOON HWANG, Seoul (KR)

(72) Inventor: UI HOON HWANG, Seoul (KR)

(21) Appl. No.: 18/518,616

(22) Filed: Nov. 24, 2023

(30) Foreign Application Priority Data
Nov. 25, 2022 (KR) 20-2022-0002774

(51) Int. Cl. A01G 17/12

(52) U.S. Cl. CPC A01G 17/12

(57) ABSTRACT

A supporting bar includes: a first fastening member which extends along a circumference of a trunk of a tree and includes a plurality of first circumferential portions each having one surface disposed in contact with a circumferential surface of the trunk of the tree and a first protruding portion disposed between the plurality of first circumferential portions and formed to protrude to extend from the first circumferential portions away from the trunk of the tree; and a second fastening member which extends along the circumference of the trunk of the tree and includes a plurality of second circumferential portions each having one surface disposed in contact with the circumferential surface of the trunk of the tree and a second protruding portion disposed between the plurality of second circumferential portions and formed to protrude to extend from the second circumferential portions away from the trunk of the tree.

### FIELD OF THE INVENTION

The present invention relates to a supporting bar for a tree, and more particularly, to a supporting bar for a tree that has a shape designed in consideration of the growth of a tree and thus can stably support the tree even in a state in which the tree has an increased thickness due to growth.

### DISCUSSION OF RELATED ART

Generally, for street trees, garden trees, orchard trees, and the like, supporting bars are installed to induce straight, upright growth of the trees and prevent the trees from falling or being uprooted due to storms or the like.

Such supporting bars are mostly made of wood and have upper end portions tied together with iron wires to support trees. Thus, there are problems in that it is inconvenient to install the supporting bars, the supporting bars are not aesthetically pleasing, and the upper end portions of the supporting bars rot over time. Further, there is a problem in that, since it is not possible to adjust a state of the supporting bars according to an increase in the thickness of a tree due to growth, the supporting bars hinder the growth of the tree.

In the present specification, a supporting bar for addressing the above problems that is easy to install and has a shape designed in consideration of the thickness of a tree according to the growth of the tree to stably support the tree will be described.

### RELATED ART DOCUMENT

Korean Patent Publication No. 10-2022-0041450

### SUMMARY OF THE INVENTION

### Problem to be Solved

The present invention is directed to a supporting bar for a tree, and more particularly, to a supporting bar for a tree that has a shape designed in consideration of the growth of a tree and thus can stably support the tree even in a state in which the tree has an increased thickness due to growth.

### Technical Solution

According to an aspect of the present invention, there is provided a supporting bar for a tree, the supporting bar including: a first fastening member which extends along a circumference of a trunk of a tree and includes a plurality of first circumferential portions each having one surface disposed in contact with a circumferential surface of the trunk of the tree and a first protruding portion disposed between the plurality of first circumferential portions and formed to protrude to extend from the first circumferential portions away from the trunk of the tree; and a second fastening member which extends along the circumference of the trunk of the tree and includes a plurality of second circumferential portions each having one surface disposed in contact with the circumferential surface of the trunk of the tree and a second protruding portion disposed between the plurality of second circumferential portions and formed to protrude to extend from the second circumferential portions away from the trunk of the tree, wherein the first fastening member and the second fastening member are coupled to each other by one side of the first fastening member being connected to one side of the second fastening member and the other side of the first fastening member being connected to the other side of the second fastening member, and the trunk of the tree is positioned in a hole formed between the first fastening member and the second fastening member as the first fastening member and the second fastening member are coupled to each other, and the tree is supported by the circumferential surface of the tree coming in contact with inner surfaces of the first circumferential portions of the first fastening member and inner surfaces of the second circumferential portions of the second fastening member.

A circumferential length of a hole formed between the trunk of the tree and each of the first protruding portion and the second protruding portion may gradually decrease away from the trunk of the tree.

### Advantageous Effect

The supporting bar may further include a connecting member having one side coupled to the first circumferential portion disposed at the one side of the first fastening member and the other side coupled to the second circumferential portion disposed at the one side of the second fastening member to connect the first fastening member and the second fastening member to each other, a plurality of holes may be formed at a tip of the second circumferential portion disposed at the other side of the second fastening member, and the first circumferential portion disposed at the other side of the first fastening member may be inserted into any one of the plurality of holes so that the other side of the first fastening member and the other side of the second fastening member are connected to each other.

The connecting member may include a first portion and a second portion vertically extending from the first portion, a tip of the first circumferential portion disposed at the one side of the first fastening member may vertically extend away from the trunk of the tree and overlap with the second portion, and the tip and the second portion may be coupled to each other while fixed by a fixer.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a supporting bar for a tree according to one embodiment of the present invention:

FIG. 2 is a detailed view of a state in which a first fastening member and a second fastening member are connected by a fixer according to one embodiment of the present invention;

FIG. 3 is an enlarged view of a first protruding portion according to one embodiment of the present invention; and

FIG. 4 is a view illustrating a state in which the supporting bar for a tree according to one embodiment of the present invention is mounted on a tree.

### DETAILED DESCRIPTION OF EXEMPLARY EMBODIMENTS

Hereinafter, embodiments of the present invention will be described in detail with reference to the accompanying drawings so that those of ordinary skill in the art to which the present invention pertains can easily carry out the present invention. However, the present invention may be implemented in various different forms and is not limited to the embodiments described herein. Also, in the drawings, in order to clearly describe the present invention, parts irrelevant to the description are omitted, and like parts are denoted by like reference numerals throughout the specification.

Throughout the specification, when a certain part is described as being “connected” to another part, this not only includes a case in which the part is “directly connected” to the other part, but also includes a case in which the part and the other part are “electrically connected” to each other with another element disposed therebetween. Also, when a certain part is described as “including” a certain component, unless particularly described otherwise, this means that the part may further include other components instead of excluding other components. Hereinafter, the present invention will be described in detail with reference to the accompanying drawings.

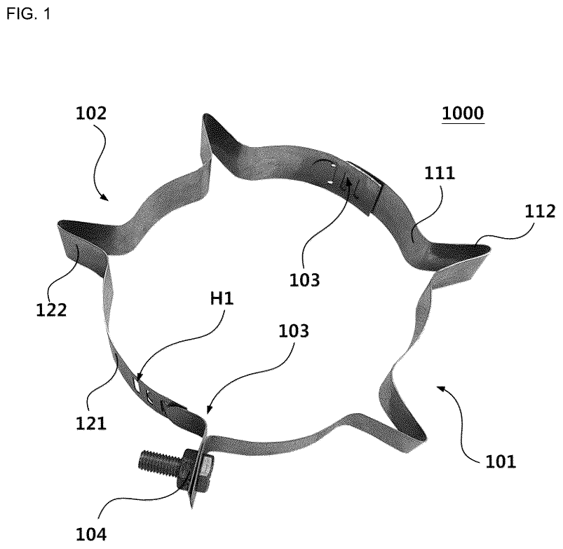

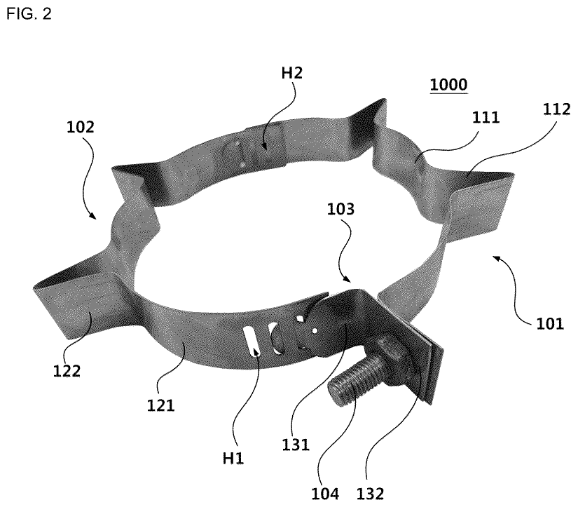

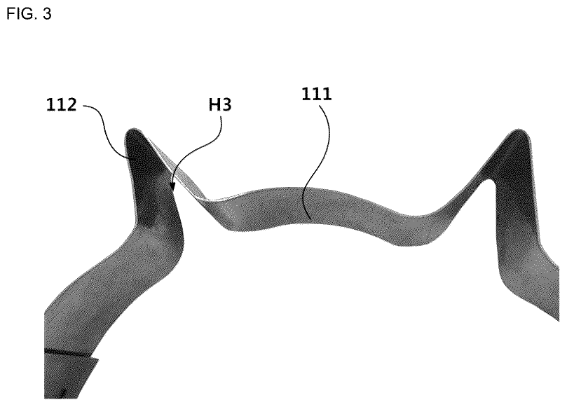

FIG. 1 is a perspective view of a tree supporting bar 1000 according to one embodiment of the present invention, FIG. 2 is a detailed view of a state in which a first fastening member 101 and a second fastening member 102 are connected by a fixer 104 according to one embodiment of the present invention, FIG. 3 is an enlarged view of a first protruding portion 112 according to one embodiment of the present invention, and FIG. 4 is a view illustrating a state in which the tree supporting bar 1000 according to one embodiment of the present invention is mounted on a tree.

Referring to FIGS. 1 and 4, the tree supporting bar 1000 according to one embodiment of the present invention may include the first fastening member 101, the second fastening member 102, and a connecting member 103.

The first fastening member 101 may include a first circumferential portion 111 and the first protruding portion 112.

The first circumferential portion 111 may extend along the circumference of a trunk of a tree and have one surface in contact with a circumferential surface of the trunk of the tree. The first circumferential portion 111 may be provided as a plurality of first circumferential portions 111. As illustrated in FIG. 1, the first circumferential portion 111 may be provided as three first circumferential portions 111. However, the number of first circumferential portions 111 is not limited. The first circumferential portion 111 may be made of a metal material. For example, the first circumferential portion 111 may be made of iron.

The first protruding portion 112 may be formed to protrude to extend from the first circumferential portion 111 away from the trunk of the tree. As illustrated in FIG. 1, the first circumferential portion 111 may be provided as three first circumferential portions 111, and the first protruding portion 112 may be provided as two first protruding portions 112 interposed between the first circumferential portions 111. However, the number of first protruding portions 112 may vary according to the number of first circumferential portions 111. The first protruding portion 112 may be made of a metal material. For example, The first protruding portion 112 may be made of iron.

The second fastening member 102 may include a second circumferential portion 121 and a second protruding portion 122.

The second circumferential portion 121 may extend along the circumference of the trunk of the tree and have one surface in contact with the circumferential surface of the trunk of the tree. The second circumferential portion 121 may be provided as a plurality of second circumferential portions 121. As illustrated in FIG. 1, the second circumferential portion 121 may be provided as three second circumferential portions 121. However, the number of second circumferential portions 121 is not limited.

The second protruding portion 122 may be formed to protrude to extend from the second circumferential portion 121 away from the trunk of the tree. As illustrated in FIG. 1, the second circumferential portion 121 may be provided as three second circumferential portions 121, and the second protruding portion 122 may be provided as two second protruding portions 122 interposed between the second circumferential portions 121. However, the number of second protruding portions 122 may vary according to the number of second circumferential portions 121.

The first fastening member 101 and the second fastening member 102 may be coupled to each other by one side of the first fastening member 101 being connected to one side of the second fastening member 102 and the other side of the first fastening member 101 being connected to the other side of the second fastening member 102.

The connecting member 103 may have one side coupled to the first circumferential portion 111 disposed at the one side of the first fastening member 101 and the other side coupled to the second circumferential portion 121 disposed at the one side of the second fastening member 102 to connect the first fastening member 101 and the second fastening member 102 to each other. The connecting member 103 may be made of a metal material like the first fastening member 101 and the second fastening member 102.

Referring to FIG. 2, the connecting member 103 may include a first portion 131 and a second portion 132 vertically extending from the first portion 131. As one example of the present invention, the connecting member 103 may have an L-shape. A tip of the first circumferential portion 111 disposed at the one side of the first fastening member 101 may vertically extend away from the trunk of the tree. As the connecting member 103 vertically extends in this way, one surface of the tip of the first circumferential portion 111 may overlap with one surface of the second portion 132, and the tip of the first circumferential portion 111 and the second portion 132 may be coupled to each other while fixed by the fixer 104 that passes through the pair of surfaces overlapping with each other.

Also, a plurality of holes H1 may be formed at a tip of the second circumferential portion 121 disposed at the one side of the second fastening member 102, and as illustrated in FIG. 2, the first portion 131 may be inserted into any one of the plurality of holes H1 so that the second fastening member 102 is connected to the second portion 132.

Therefore, the one side of the first fastening member 101 and the one side of the second fastening member 102 may be connected to each other via the connecting member 103.

A plurality of holes H2 may be formed at a tip of the second circumferential portion 121 disposed at the other side of the second fastening member 102, and as illustrated in FIG. 1, the first circumferential portion 111 disposed at the other side of the first fastening member 101 may be inserted into any one of the plurality of holes H2 so that the other side of the first fastening member 101 and the other side of the second fastening member 102 are connected to each other.

In this way, the tree supporting bar 1000 of the present invention may surround a trunk of a tree using the two fastening members 101 and 102 to support the corresponding tree, may connect the one side of the first fastening member 101 and the one side of the second fastening member 102 using the L-shaped connecting member 103 to strengthen a coupling force to the tree, and may connect the other side of the first fastening member 101 and the other side of the second fastening member 102 by insertion of the first circumferential portion 111 into a hole formed in the second circumferential portion 121 in order to facilitate detachment.

Referring to FIGS. 1, 3, and 4, a circumferential length of a hole H3 formed between the trunk of the tree and each of the first protruding portions 112 and the second protruding portions 122 may gradually decrease away from the trunk of the tree. When the first fastening member 101 and the second fastening member 102 are connected to each other and support the trunk of the tree as illustrated in FIG. 4, the hole H3 (space) may be formed between the trunk of the tree and each of the first protruding portions 112 and the second protruding portions 122, and the circumferential length of the corresponding hole H3 may gradually decrease away from the trunk of the tree. For example, the first protruding portions 112 and the second protruding portions 122 may each have a triangular shape that gradually narrows outward.

As the circumferential length of the hole H3 formed between the trunk of the tree and each of the first protruding portions 112 and the second protruding portions 122 is formed to gradually decrease outward, even when the tree grows and the thickness of the trunk increases, the circumferential length of the corresponding hole H3 may gradually increase to reliably support the tree, and it is possible to prevent loosening of coupling of the tree supporting bar 1000 or breakage of the tree supporting bar 1000 due to the growth of the tree.

A supporting bar for a tree of the present invention can surround a trunk of a tree using two fastening members to support the corresponding tree, can connect one side of a first fastening member and one side of a second fastening member using an L-shaped connecting member to strengthen a coupling force to the tree, and can connect the other side of the first fastening member and the other side of the second fastening member by insertion of a first circumferential portion into a hole formed in a second circumferential portion in order to facilitate detachment.

Further, since a circumferential length of a hole formed between the trunk of the tree and each of a first protruding portion and a second protruding portion is formed to gradually decrease outward, even when the tree grows and the thickness of the trunk increases, the circumferential length of the corresponding hole may gradually increase to reliably support the tree, and it is possible to prevent loosening of coupling of the supporting bar or breakage of the supporting bar due to the growth of the tree.

The above-described embodiments are only for illustrative purposes, and those of ordinary skill in the art to which the above-described embodiments pertain should understand that the above-described embodiments may be easily modified to other specific forms without changing the technical spirit or essential features of the above-described embodiments. Therefore, the above-described embodiments should be understood as illustrative, instead of limiting, in all aspects. For example, each component described as a single type may be embodied in a distributed manner, and likewise, components described as being distributed may be embodied in a combined form.

The scope of the present specification is shown by the claims below rather than by the detailed description above, and all changes or modifications derived from the meaning and scope of the claims and their equivalent concepts should be construed as falling within the scope of the present specification.

### DESCRIPTION OF THE REFERENCE NUMBER

| | |
|---|---|
| 1000: tree supporting bar | 103: connecting member |
| 101: first fastening member | 104: fixer |
| 102: second fastening member | 111: first circumferential portion |

1. A supporting bar for a tree, the supporting bar comprising:
a first fastening member which extends along a circumference of a trunk of a tree and includes a plurality of first circumferential portions each having one surface disposed in contact with a circumferential surface of the trunk of the tree and a first protruding portion disposed between the plurality of first circumferential portions and formed to protrude to extend from the first circumferential portions away from the trunk of the tree; and
a second fastening member which extends along the circumference of the trunk of the tree and includes a plurality of second circumferential portions each having one surface disposed in contact with the circumferential surface of the trunk of the tree and a second protruding portion disposed between the plurality of second circumferential portions and formed to protrude to extend from the second circumferential portions away from the trunk of the tree,
wherein the first fastening member and the second fastening member are coupled to each other by one side of the first fastening member being connected to one side of the second fastening member and the other side of the first fastening member being connected to the other side of the second fastening member, and
the trunk of the tree is positioned in a hole formed between the first fastening member and the second fastening member as the first fastening member and the second fastening member are coupled to each other, and the tree is supported by the circumferential surface of the tree coming in contact with inner surfaces of the first circumferential portions of the first fastening member and inner surfaces of the second circumferential portions of the second fastening member.

2. The supporting bar of claim 1, wherein a circumferential length of a hole formed between the trunk of the tree and each of the first protruding portion and the second protruding portion gradually decreases away from the trunk of the tree.

3. The supporting bar of claim 2, further comprising a connecting member having one side coupled to the first circumferential portion disposed at the one side of the first fastening member and the other side coupled to the second circumferential portion disposed at the one side of the second fastening member to connect the first fastening member and the second fastening member to each other,
wherein a plurality of holes are formed at a tip of the second circumferential portion disposed at the other side of the second fastening member, and the first circumferential portion disposed at the other side of the first fastening member is inserted into any one of the plurality of holes so that the other side of the first fastening member and the other side of the second fastening member are connected to each other.

4. The supporting bar of claim 3, wherein:
the connecting member includes a first portion and a second portion vertically extending from the first portion; and
a tip of the first circumferential portion disposed at the one side of the first fastening member vertically extends away from the trunk of the tree and overlaps with the second portion, and the tip and the second portion are coupled to each other while fixed by a fixer.
